(19) United States
(12) Patent Application Publication
(10) Pub. No.: US 2007/0188278 A1
(43) Pub. Date: Aug. 16, 2007

(54) Electromagnetic switch and related manufacturing method

(75) Inventors: Mikio Tsukada, Toyoake-shi (JP); Shinji Usami, Okazaki-shi (JP)

Correspondence Address: OLIFF & BERRIDGE, PLC, P.O. BOX 19928, ALEXANDRIA, VA, 22320, US

(73) Assignee: DENSO CORPORATION, Kariya-City (JP)

(21) Appl. No.: 11/647,258

(22) Filed: Dec. 29, 2006

(30) Foreign Application Priority Data
Feb. 13, 2006 (JP) 2006-035381
Aug. 11, 2006 (JP) 2006-220136

(51) Int. Cl. H01H 67/02

(52) U.S. Cl. 335/132

(57) ABSTRACT

An electromagnetic switch and related manufacturing method are disclosed having an electromagnetic coil creating an electromagnet when energized, a stationary core associated with the electromagnetic coil and operative to be magnetized when the electromagnet is created, one set of stationary contacts disposed in areas away from the stationary core, and a plunger carrying thereon a movable contact and operative to move toward the stationary contacts to close the same when the stationary core is magnetized by the electromagnet. The stationary core includes a base section and a disc section assembled to the base section. The disc section includes a plurality of stacked thin plates, fixedly secured to each other by fixing means, which have through-openings extending to each other in a circumferential direction in communication with each other to form a coil takeout opening through which an end portion of the electromagnetic coil is extracted.

### CROSS REFERENCE TO RELATED APPLICATIONS

This application is related to Japanese Patent Application No. 2006-35381 and No. 2006-220136, filed on Feb. 13, 2006 and Aug. 11, 2006, respectively, the contents of which are hereby incorporated by reference.

### BACKGROUND OF THE INVENTION

1. Technical Field of the Invention

The present invention relates to electromagnetic switches for use in starters for starting up engines and, more particularly, to an electromagnetic switch adapted to open or close electrical contacts disposed in an energization circuit of a starter motor.

2. Description of the Related Art

Various attempts have heretofore been to provide electromagnetic switches for use in starting up starter motors, with one of such electromagnetic switches being disclosed in U.S. Pat. No. 6,281,770 (Japanese Unexamined Patent Application Publication No. 2002-524826).

With such a related art, the electromagnetic switch includes an electromagnetic coil and a stationary core that is magnetized when the electromagnetic coil is energized upon receipt of electric power.

As shown in FIG. 12, the stationary core is constructed of a base section 100 and a disc section 110.

The disc section 110, composed of a plurality of stacked disc-like thin plates 112, has a central area formed with a round bore 111. In assembly, a cylindrical portion 101 of the base section 100 is press fitted to an inner periphery of the round bore 111 of the disc section 110 into one piece.

Further, with the disc section 110, the disc-like thin plates 112 have outer peripheries formed with recessed portions 113 at symmetric positions with respect to a center of the disc section 110 for extracting an end portion of the electromagnetic coil. In addition, the thin plate 112a on the outermost layer of the disc section is formed with a press-out retaining lug 114 for retaining the end portion 130 of the electromagnetic coil.

With such a structure of the stationary core of the related art, the recessed portions 113, formed on the respective thin plates 112, needs to be aligned in position when fixing the disc section 110 to the base section 100. That is, a need arises a plurality of thin plates 112 to be stacked and fixedly secured while aligning the recessed portions 113 in position one by one. In an alternative, the plurality of thin plates 112 need to be fixed to the base section 100 under a condition where the plurality of thin plates 112 are maintained in a positioned state with the recessed portions 113 aligned in an axial direction of the base section 100, causing an issue with the occurrence of an increase in man-hour in assembly.

Further, since the thin plate 112a placed on the outermost layer of the disc section 110 is formed with the press-out retaining lug 114, the press-out retaining lug 114 cumbers work of soldering the ed portion 130 of the electromagnetic coil to the surface of the thin plate 112a, causing deterioration in workability.

Furthermore, the end portion 130a of the electromagnetic coil soldered to the surface of the thin plate 112a is applied with an impact force occurring when a movable core is brought into contact with the base portion 100 to cause damage to a soldered portion. To avoid such damage, the press-out retaining lug 114, formed on the thin plate 112a, needs to reliably hold the end portion 130 (at a position near the soldered portion) of the electromagnetic coil. Therefore, the press-out retaining lug 114 needs to be formed on the thin plate 112a placed on the outermost layer of the disc section 110 and, hence, the thin plate 112a has a configuration different from the other thin plates 112, causing an increase in production cost.

### SUMMARY OF THE INVENTION

The present invention has been completed with a view to addressing the above issue and has an object to provide an electromagnetic switch and a related manufacturing method that can achieve a reduction in man-jour in assembling a disc section to a base section while enabling the disc section to be fabricated using a plurality of thin plates with the same shape.

To achieve the above object, one aspect of the present invention provides an electromagnetic switch comprising an electromagnetic coil creating an electromagnet when energized, a stationary core operative to be magnetized by the electromagnet created by the electromagnetic oil, stationary electrical contacts fixedly disposed in a position away from the stationary core, and a movable contact movable with a plunger attracted by the magnetized stationary core in a direction to close the stationary electrical contacts. The stationary core includes a base section and a disc section, assembled to the base section, which is disposed in an area on one side of the electromagnetic coil and has a coil takeout opening through which an end portion of the electromagnetic coil is extracted. The disc section includes a plurality of stacked thin plates, formed in the same shapes, which have through-openings extending in a thickness direction of the disc section, respectively, and aligned to communicate with each other to form the coil takeout opening. Fixing means is associated with the stacked thin plates to fixedly secure stacked thin plates with each other under a circumstance where the through-openings are aligned with each other with respect to a circumferential direction of the disc section.

With such a structure, the plural thin plates are fixedly secured to each other before assembling the disc section to the base section under a circumstance where the plural thin plates are fixed to each other by means of the fixing means in a way to allow the through-openings to be positioned with respect to each other. Thus, no need arises for positioning the plural thin plates one by one during assembly thereof. This results in simplified handling of the component parts during assembling steps, while enabling a reduction in man-hour needed for assembling the component parts with the resultant improvement in productivity.

With the electromagnetic switch of the present embodiment, the end portion of the electromagnetic coil may be extracted from the coil takeout opening of the disc section to one surface of the outermost layer of the stacked thin plates at a position remote from the electromagnetic coil and jointed to the one surface of the outermost layer of the stacked thin plates by one of welding and soldering. The disc section has a fixing portion, through which the plurality of stacked thin plates are fixed by the fixing means, which has a height substantially equal to a thickness of the disc section.

In such a case, no probability takes place for the fixing portion protrudes from the surfaces of the outermost thin plates in the outermost layers of the disc section. Thus, the fixing portion invites no disturbance for the end portion of the electromagnetic coil to be welded or soldered to the surface of the thin plate, resulting in an increase in productivity.

With the electromagnetic switch of the present embodiment, the end portion of the electromagnetic coil is jointed to the one surface of the outermost layer of the stacked thin plates by one of the welding and soldering at an area close proximity to the fixing portion.

With such a structure, the fixing portion through which the plural thin plates are fixedly secured with the use of the fixing means can provide increased strength, causing less deviation of the fixing portion during an impact applied when the movable core strikes the base section. Thus, providing a joint section of the electromagnetic coil in an area close proximity to the fixing portion enables a reduction of damage to the joint portion. Therefore, no need arises for the thin plate, placed in the outermost layer of the disc section, to be processed to have a particular shape such as the press-out retaining lug, required in the prior art disclosed in Patent Document I, for retaining the end portion of the electromagnetic coil. Thus, the thin plate placed in the outermost layer of the disc section can have the same shape as those of the other thin plates, providing increased productivity and simplified assembling steps.

With the electromagnetic switch of the present embodiment, the stacked thin plates of the disc section are fixed to each other by caulking.

The use of caulking as the fixing means allows the thin plates to be fixed to each other with no need for skilled technique of a worker in contrast to a method of fixing the thin plates by welding or the like, thereby providing stabilized quality of the fixing portion (that is, the caulked portion).

According to another aspect of the present invention, there is provided a method of manufacturing an electromagnetic switch, the method comprising the steps of preparing an electromagnetic coil creating an electromagnet when energized, preparing a stationary core to be placed in a position adjacent to the electromagnetic coil, fixedly mounting stationary electrical contacts in a position away from the stationary core, and mounting a movable contact on a plunger operative to be attracted by the stationary core, when the electromagnetic coil is energized, to move in a direction to close the stationary electrical contacts. The stationary core preparing step includes the step of preparing a base section associated with the electromagnetic coil, forming a plurality of thin plates having the same shapes and having through-openings, respectively, stacking the plurality of thin plates in a way to allow the through-openings to be aligned with each other with respect to a circumferential direction, caulking the stacked thin plates at a caulked portion in a lump to prepare a disc section, assembling the disc section and the base section into the stationary core, and extracting an end portion of the electromagnetic coil through the takeout opening.

With such a manufacturing method, fixing the plurality of thin plates by caulking in a lump sum enables assembling man-hour to be shortened. In addition, the step of fixing the plurality of thin plates with the use of caulking technique provides no need for skilled technology of a worker. This allows the stator core to have stabilized quality in respect of the fixing portion (the caulked portion).

With the method of manufacturing the electromagnetic switch of the present invention, the step of forming a plurality of thin plates may include the steps of forming the thin plates by punching, and forming the caulked portion, to be caulked, by press forming.

In such a case, the thin plates can be formed by punching, enabling the thin plates to be fabricated in an extremely easy manner on a mass production basis. In addition, preliminarily forming the caulking portion by press forming enables caulking work to be done in an easy manner, resulting in improved productivity.

Another aspect of the present invention provides a method of manufacturing an electromagnetic switch, the method comprising the steps of preparing an electromagnetic coil creating an electromagnet when energized, preparing a stationary core to be placed in a position adjacent to the electromagnetic coil, fixedly mounting stationary electrical contacts in a position away from the stationary core, and mounting a movable contact on a plunger operative to be attracted by the stationary core, when the electromagnetic coil is energized, to move in a direction to close the stationary electrical contacts. The stationary core preparing step includes the step of preparing a base section associated with the electromagnetic coil, forming a plurality of thin plates having the same shapes and having through-openings, respectively, stacking the plurality of thin plates in a way to allow the through-openings to be aligned with each other with respect to a circumferential direction, caulking the stacked thin plates at a caulked portion one by one in a sequence to prepare a disc section, assembling the disc section and the base section into the stationary core, and extracting an end portion of the electromagnetic coil through the takeout opening.

With such a manufacturing method, stacking the thin plates one by one and sequentially performing caulking and fixing steps enables the plurality of thin plates to be fixed to each other in a highly reliable manner. In addition, the step of fixing the plurality of thin plates with the use of caulking technique provides no need for skilled technology of a worker. This allows the stator core to have stabilized quality in respect of the fixing portion (the caulked portion).

With the method of manufacturing the electromagnetic switch of the present invention, the step of forming a plurality of thin plates may include the steps of forming the thin plates by punching, and forming the caulked portion, to be caulked, by press forming.

In such a case, the thin plates can be formed by punching, enabling the thin plates to be fabricated in an extremely easy manner on a mass production basis. In addition, preliminarily forming the caulking portion by press forming enables caulking work to be done in an easy manner, resulting in improved productivity.

Another aspect of the present invention provides an electromagnetic switch comprising an electromagnetic coil creating an electromagnet when energized, a plunger movably disposed in the electromagnetic coil and having a shaft axially extending from one end of the plunger, a stationary core associated the electromagnetic coil and operative to be magnetized by the electromagnet created by the electromagnetic oil, stationary electrical contacts disposed in positions away from the stationary core, and a movable contact, carried on one end of the shaft, which is normally urged in a position to open the electrical contacts and movable in a direction to close the stationary electrical contacts when the stationary core is magnetized by the electromagnetic coil. The stationary core includes a base section, and a disc section, assembled to the base section, which is disposed in an area on one side of the electromagnetic coil and has a coil takeout opening through which an end portion of the electromagnetic coil is extracted. The disc section includes a plurality of stacked thin plates, formed in the same shapes, which have through-openings extending in a thickness direction of the disc section, respectively, and aligned to communicate with each other to form the coil takeout opening.

With such a structure, the plural thin plates are fixedly secured to each other before assembling the disc section to the base section under a circumstance where the plural thin plates are fixed to each other by means of the fixing means in a way to allow the through-openings to be positioned with respect to each other. Thus, no need arises for positioning the plural thin plates one by one during assembly thereof. This results in simplified handling of the component parts during assembling steps, while enabling a reduction in man-hour needed for assembling the component parts with the resultant improvement in productivity.

With the electromagnetic switch of the present embodiment, the stacked thin plates may be fixedly secured to each other by caulking under a circumstance where the through-openings are aligned with each other with respect to a circumferential direction of the disc section in communication with each other.

In such a case, caulking the stacked thin plates under the circumstance where the through-openings are aligned with each other allows the disc section to be fabricated in a simplified step with no need for skilled technique of a worker. This allows the stator core to have stabilized quality in respect of the fixing portion (the caulked portion).

With the electromagnetic switch of the present embodiment, the stacked thin plates may be fixedly secured to each other by a positioning pin press fitted to the stacked thin plates under a circumstance where the through-openings are aligned with each other with respect to a circumferential direction of the disc section in communication with each other.

With such a structure, since the stacked thin plates can be fixedly secured to each other with the use of the positioning pin press fitted to the stacked thin plates, stacked thin plates can be fabricated in increased precision on a mass production basis, while maintaining highly increased dimensional quality. This allows a reduction in cost and an increase in productivity.

With the electromagnetic switch of the present embodiment, the stacked thin plates may be fixedly secured to each other by a rivet inserted to the stacked thin plates under a circumstance where the through-openings are aligned with each other with respect to a circumferential direction of the disc section in communication with each other.

With such a structure, since the stacked thin plates can be fixedly secured to each other with the use of the rivet inserted to the stacked thin plates, stacked thin plates can be fabricated in increased precision on a mass production basis, while maintaining highly increased dimensional quality. This allows a reduction in cost and an increase in productivity.

With the electromagnetic switch of the present embodiment, the stacked thin plates may be fixedly secured to each other by a spring pin inserted to the stacked thin plates under a circumstance where the through-openings are aligned with each other with respect to a circumferential direction of the disc section in communication with each other.

With such a structure, since the stacked thin plates can be fixedly secured to each other with the use of the spring pin inserted to the stacked thin plates, stacked thin plates can be fabricated in increased precision on a mass production basis, while maintaining highly increased dimensional quality. This allows a reduction in cost and an increase in productivity.

With the electromagnetic switch of the present embodiment, the end portion of the electromagnetic coil may be extracted from the coil takeout opening of the disc section to one surface of the outermost layer of the stacked thin plates at a position remote from the electromagnetic coil and jointed to the one surface of the outermost layer of the stacked thin plates by one of welding and soldering. The disc section may have a fixing portion, through which the plurality of stacked thin plates are fixed by the fixing means, which has a height substantially equal to a thickness of the disc section.

With such a structure, the fixing portion through which the plural thin plates are fixedly secured with the use of the fixing means can provide increased strength, causing less deviation of the fixing portion during an impact applied when the movable core strikes the base section. Thus, providing a joint section of the electromagnetic coil in an area close proximity to the fixing portion enables a reduction of damage to the joint portion. Therefore, no need arises for the thin plate, placed in the outermost layer of the disc section, to be processed to have a particular shape such as the press-out retaining lug, required in the prior art disclosed in Patent Document I, for retaining the end portion of the electromagnetic coil. Thus, the thin plate placed in the outermost layer of the disc section can have the same shape as those of the other thin plates, providing increased productivity and simplified assembling steps.

With the electromagnetic switch of the present embodiment, the end portion of the electromagnetic coil may be jointed to the one surface of the outermost layer of the stacked thin plates by one of welding and soldering at an area close proximity to the fixing portion.

In such a case, the thin plate placed in the outermost layer of the disc section can have the same shape as those of the other thin plates, providing increased productivity and simplified assembling steps.

### BRIEF DESCRIPTION OF THE DRAWINGS

FIG. 1 is a cross sectional view, taken on line B-B of FIG. 2, showing a stationary core of an electromagnetic switch of a first embodiment according to the present invention.

FIG. 2 is a plan view of the stationary core shown in FIG. 1 as viewed from a base section forming part of the stationary core.

FIGS. 3A to 3C are schematic views showing a basic sequence of forming thin plates for use in a disc section forming part of the stationary core shown in FIGS. 1 and 2.

FIG. 4 is a plan view of the stationary core as viewed from the disc section.

FIG. 5 is a side view of the stationary core shown in FIG. 4.

FIG. 6 is a cross sectional view of the electromagnetic switch incorporating the stationary core shown in FIGS. 1 and 2 and FIGS. 4 and 5.

FIG. 7 is a circuit diagram of the electromagnetic switch shown in FIG. 6.

FIG. 8 is a cross sectional view, taken on line B-B of FIG. 9, showing a stationary core of an electromagnetic switch of a second embodiment according to the present invention.

FIG. 9 is a plan view of the stationary core shown in FIG. 8 as viewed from a base section forming part of the stationary core.

FIG. 10 is a cross sectional view showing a stationary core of an electromagnetic switch of a third embodiment according to the present invention.

FIG. 11 is a cross sectional view showing a stationary core of an electromagnetic switch of a fourth embodiment according to the present invention.

FIG. 12 is an exploded perspective view showing a stationary core of an electromagnetic switch of the related art.

### DETAILED DESCRIPTION OF PREFERRED EMBODIMENTS

Now, electromagnetic switches of various embodiments according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

### First Embodiment

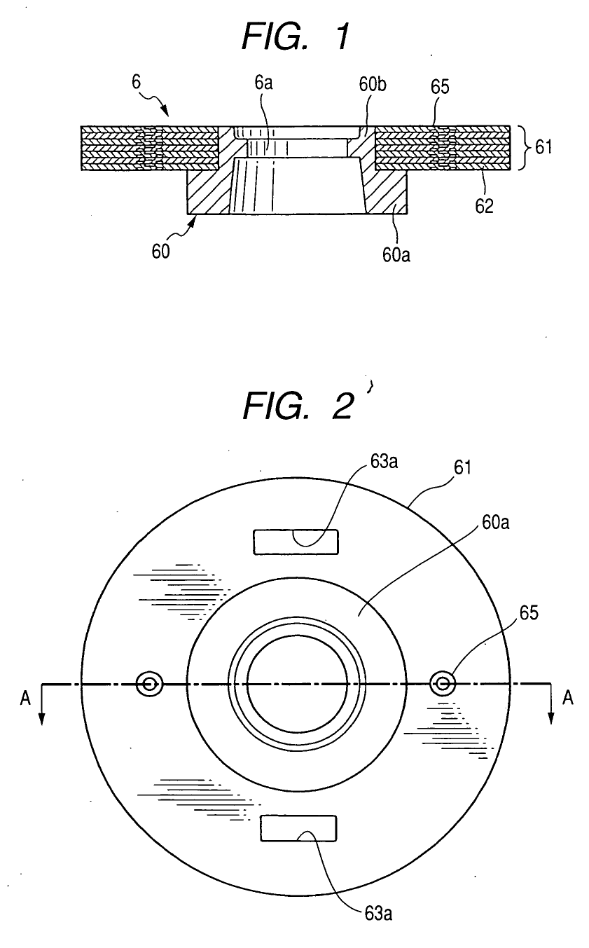

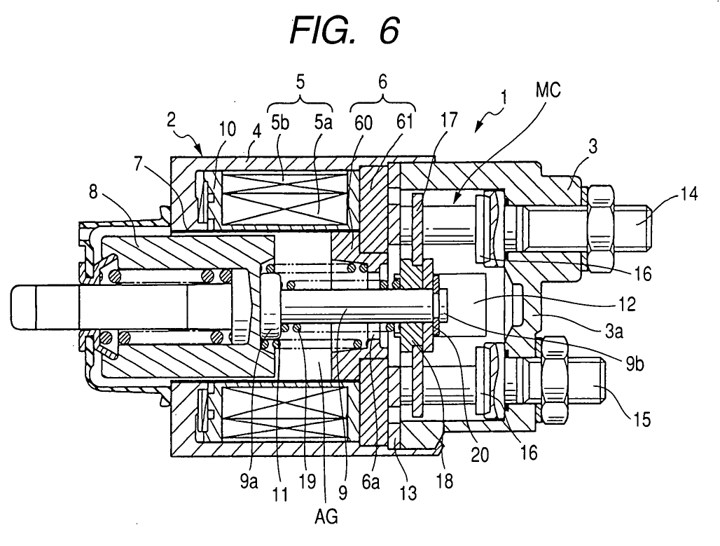

FIG. 1 is a cross sectional view, taken on line B-B of FIG. 2, which shows a stator core 6; FIG. 2 is a plan view of the stator core 6 as viewed from a base section 60; and FIG. 6 is a cross sectional view of an electromagnetic switch 1.

The electromagnetic switch 1 (see FIG. 6) of the first embodiment, used in a starter (not shown) for starting up an engine of a motor vehicle, has a function to close a main contact MC disposed in a motor energizing circuit (herein referred to as a motor circuit). As shown in FIG. 6, the electromagnetic switch 1 comprises a solenoid 2 with which an electromagnet is formed, and a switch cover 3 fixedly secured to the solenoid 2.

The solenoid 2 comprises a switch case 4 forming a yoke, an electromagnetic oil 5 received inside the switch case 4, a stationary core 6 that is magnetized upon energizing the electromagnetic oil 5, a plunger (movable contact) 8 slidably inserted to an interior of the electromagnetic oil 5 via a sleeve, and a shaft 9 integrally movable with the plunger 8.

The electromagnetic oil 5 comprises an attraction coil 5a operative generate a magnetic force for attracting the plunger 8, and a holder coil 5b operative to generate a magnetic force for holding the attracted plunger 8, with the attraction coil 5a and the holder coil 5b being wound on a bobbin, made of resin, in a double layered status.

The stationary core 6, made of ferromagnetic material (such as iron), creates a magnetic circuit around the electromagnetic oil 5 in association with the switch case 4 and the plunger 8. A detailed structure of the stationary core 6 will be described later.

The plunger 8 is disposed in the interior of the sleeve 7 in opposition to the stationary core 6. The shaft 9 carries thereon a return spring 11 in an area between the stationary core 6 and the plunger 8. The return spring 11 urges the plunger 8 in a direction (leftward in FIG. 6) opposite to the stationary core 6 such that an air gap AG is provided between the stationary core 6 and the plunger 8.

The shaft 9 has one end formed with a flange portion 9a, which is fixed to an end face of the plunger 8 to be integrally movable with the plunger 8. The shaft 9 has the other end extending through a center bore 6a of the stationary core 6 and penetrates into a contact chamber 12 formed in an area near a rear end wall 3a of the switch cover 3.

The switch cover 3, composed of, for instance, a resin product, is fixedly secured to the switch case 4 by caulking with a rubber packing 13 intervening between the switch cover 3 and the switch case 4 while the contact chamber 12 faces the rubber packing 13.

The main contact MC comprises one set of stationary cores 16, 16, connected to the motor circuit via two external terminals 14, 15 fixedly mounted on the switch cover 13, and a movable contact 17 for connecting or disconnecting the one set of stationary cores 16, 16.

The movable contact 17 is mounted on an end of the shaft 9 that penetrates into the contact chamber 12 and urged toward a distal end 9b of the shaft 9 (that is, rightward as viewed in FIG. 6) by means of a contact pressure spring 19, carried on the shaft 9 in an area between the flange 9a of the shaft 9 and an insulating member 18, into abutting contact with a stopper member 20 mounted on the distal end 9b of the shaft 9 to prevent a drop-off of the movable contact 17.

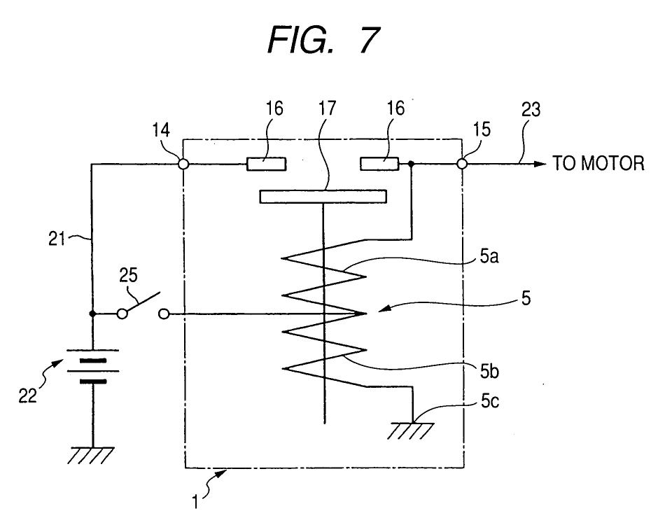

As shown in FIG. 7, the two external terminals 14, 15 include a B-terminal 14 and an M-terminal 15, respectively, which are connected to the stationary cores 16, 16, respectively, with one external terminal 14 being electrically connected through a battery cable 21 to an on-vehicle battery 22 while the other external terminal 14 is electrically connected to a lead wire 23 extracted from the motor (not shown).

Subsequently, a structure of the stationary core 6 of the present invention is described below in detail with reference to FIGS. 1 and 2.

The stationary core 6 comprises a section 60, having one end facing the plunger 8 and the other end facing the movable contact 17, and a disc section 61 combined with the base section 60 and placed in a position facing one end of the electromagnetic coil 5.

As shown in FIG. 1, the base section 60 takes the form of an annular body having a central area formed with the center bore 6a and includes a large diameter portion 60a, which mates with an inner periphery of the sleeve 7, and a small diameter portion 60b press fitted to the disc section 61.

The disc section 61 includes a plurality of thin disc plates 62 (with seven sheets in the embodiment shown in FIG. 1), formed in the same configuration, which are stacked and caulked into one piece. The disc section 61 is formed with two axially extending coil takeout openings 63a for taking out end portions of the electromagnetic oil 5 to areas remote from the disc section 6 in opposition to the electromagnetic oil 5 (in a rightward direction as viewed in FIG. 6).

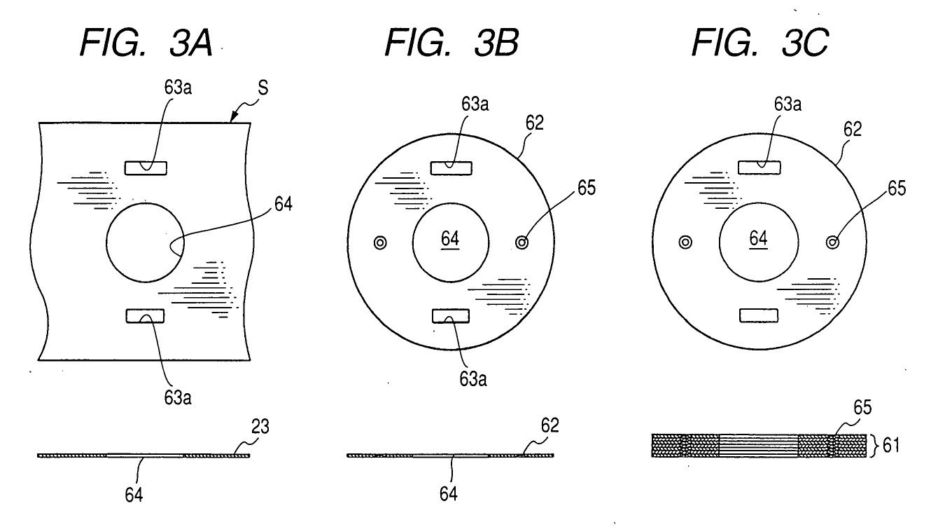

As shown in FIGS. 3A to 3C, each thin disc plate 62 is formed from a band-like sheet plate S (such as a band-like steel plate) of row material by press forming. A basic sequence of pressing steps for fabricating the thin disc plate 62 is carried in the manner as follows:

(a) First step of punching oblong through-bores: As shown in FIG. 3A, press punching is carried out on the band-like sheet plate R to form a round bore 64 in a center position between both sides of the sheet plate S and two oblong through-bores 63a, acting as the respective coil takeout openings, each between one side of the sheet plate S and an inner periphery of the round bore 64. The round bore 64 has substantially the same diameter as an outer diameter of the small diameter portion 60b of the base section 60. With plural thin disc plates 62 stacked into one piece as described below in detail, the oblong through-bores 63a communicate with each other along a center axis of the round bore 64, forming the coil takeout openings 63a in areas on both sides of the round bore 64.

(b) Second step of forming caulking portions 65: As shown in FIG. 3B, press punching is carried out to form an outer diametric shape of the thin disc plate 62 and caulking portions 65 are formed by pressing. The caulking portions 65 are formed at, for instance, two positions on a radial line passing across the center of the round bore 64.

(c) Third step of stacking the thin disc plates 62: The plural thin disc plates 62, formed by press forming, are then stacked. The stacking operations are carried out such that the thin disc plates 62 are aligned so as to allow the oblong through-bores 63a to match each other in circumferential directions whereby the oblong through-bores 63a communicate with each other in a stacked direction.

(d) Fourth step of caulking: As shown in FIG. 3C, caulking is collectively carried out on the plural disc plates 62, which are stacked in one set, at the caulking portions 65 for rigidly fasten the plural disc plates 62 to each other, thereby forming the disc section 61.

(e) Fifth step of press fitting: As shown in FIG. 1, the disc section 61 is press fitted to an outer periphery of the small diameter portion 60b of the base section 60 to assemble the base section 60 and the disc section 61 into a unitary assembly as the stationary core 6.

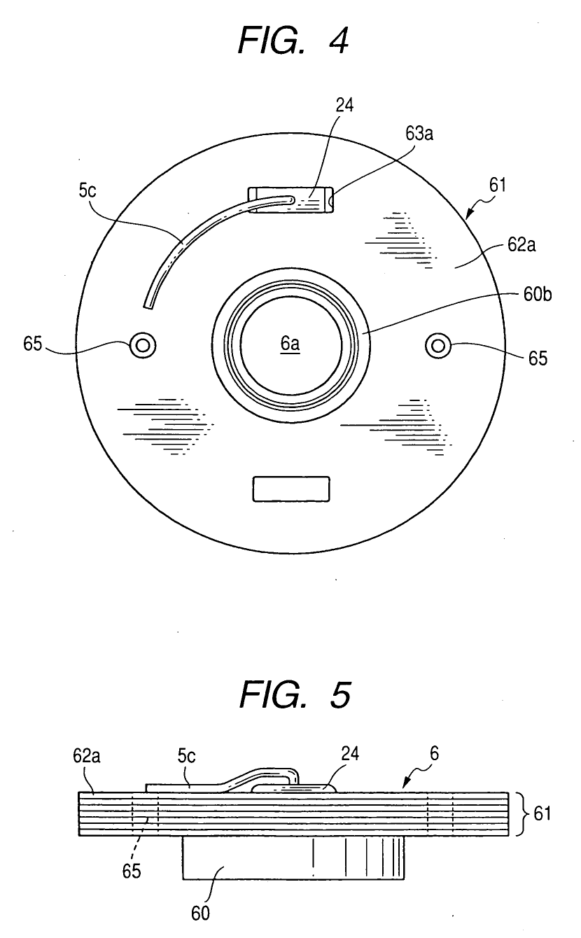

As shown in FIGS. 4 and 5, the electromagnetic coil has the holder coil 5b whose ground-side coil end 5c (see FIG. 7) is taken out from one of the coil takeout openings 63a of the disc section 61 by means of a coil holder 24, formed integrally with the bobbin 10 (see FIG. 1) and exposed to an outside of the disc section 61. Then, the ground-side coil end 5c is jointed to a surface of the outermost layer 62a of the disc section 61 by welding or soldering. The ground-side coil end 5c is taken out of the coil takeout opening 63a to the outside of the disc section 61 and, thereafter, caused to extend by a given distance in a circumferential direction of the disc section 61 upon which the ground-side coil end 5c is jointed to the uppermost layer 62a of the disc section 61 in an area close proximity to one of the caulking portion 65.

Next, the operation of the electromagnetic switch 5 is described below.

As a start switch 25 is turned on to energize the electromagnetic coil 5 (see FIG. 7), the electromagnet is created to magnetize the stationary core 6. When this takes place, an attraction force acts on both the base section 60 of the stationary core 6 and the plunger 8. This causes the plunger 8 to move toward the base section 60 (rightward as viewed in FIG. 6) against the force of the return spring 11. Due to the movement of the plunger 8, the shaft 9 fixed to the plunger 8 is pushed to cause the movable contact 17, supported on the end of the shaft 9, to be brought into abutting contact with the one set of stationary cores 16, 16. Thereafter, the plunger 8 moves further rearward while compressing the contact pressure spring 19 into abutting contact with the base section 60 of the stationary core 6 upon which the plunger 8 remains under a stopped state.

With the plunger 8 remaining under the stopped state, the movable contact 17 is applied with compressive load of the contact pressure spring 19 and the movable contact 17 is forced to be held in contact with the one set of the stationary cores 16, 16. Thus, the main contact MC is kept in a closed state, permitting the on-vehicle battery 22 to supply electric power to the motor. Then, the drive torque of the motor is transferred through the output shaft of the starter to the pinion gear, mounted on the output shaft, through which the drive torque is delivered to the engine via the ring gear thereof, thereby cranking up the engine.

After the engine has started up, the start switch 25 is turned off to interrupt the supply of electric power to the electromagnetic coil 5 with the attraction force of the electromagnet being distinguished. When this takes place, the plunger 8 is restored to its original position by the reactive force of the return spring 11 in a direction away from the base section 50 of the stationary core 6. Thus, the movable contact 17 is removed away from the one set of stationary cores 16, 16 to allow the main contact MC to be brought into an open condition, thereby interrupting the supply of electric power to the motor.

(Advantageous Effects of First Embodiment)

With the electromagnetic switch 1 of the present embodiment, since the stationary core 6 takes the form of a structure including the base section 60 and the disc section 61 in a combined configuration. Before assembling the disc section 61 onto the base section 60, the plural thin disc plates 62, forming the disc section 61, are stacked so as to align the oblong through-bores 63a with respect to each other in the circumferential direction of the disc section 61 and the plural thin disc plates 62 are caulked at the caulking portions 65 with the oblong through-bores 63a communicating with each other. This avoids no need for positioning the thin disc plates 62 one by one when assembling the disc section 61 and the base section 60. This results in simplified handling of the component parts during assembling operations thereof, while achieving reduction in man-hour needed for assembly with the resultant improvement over productivity of the electromagnetic switch 1.

Further, the caulking portions 65 through which the plural disc plates 62 are fixedly secured to each other, provide increased rigidity to the disc section 61, thereby minimizing displacement (vibration) of the base section 60 when the plunger 8 is caused to strike the base section 60 of the stationary core 6. Accordingly, extracting the ground-side coil end 5c of the electromagnet coil 5 from the coil takeout opening 63a and extending the ground-side coil end 5c to the area near one of the caulking portions 65, upon which the ground-side coil end 5c is jointed to the surface of the disc plate 62a (see FIG. 4), enables a reduction in damage to a coil joint portion due to impact when the plunger 8 is caused to strike the base section 60 of the stationary core 6. Thus, no need arises for working to be done to form a specifically contoured segment (such as, for instance, the press-out retaining lug 114 as shown in FIG. 12) on the disc plate 62a placed on the outermost layer of the disc section 61 for retaining the ground-side coil end 5c of the electromagnetic coil 5 at an area close proximity to a coil joint portion. Therefore, the outermost disc plate 62 can be formed in the same structure as the other disc plates 62, enabling a reduction in production cost of the disc plates 62.

While the stationary core 6 of the present embodiment has been described with reference to an example wherein the plural disc plates 62 are stacked and then caulked in a collective way, the present invention is not limited to such a fabricating process and the plural disc plates 62 may be stacked one by one and sequentially subjected to caulking steps.

Further, the caulking portions 65 may be formed on a stage of punching as shown in FIG. 3A.

### Second Embodiment

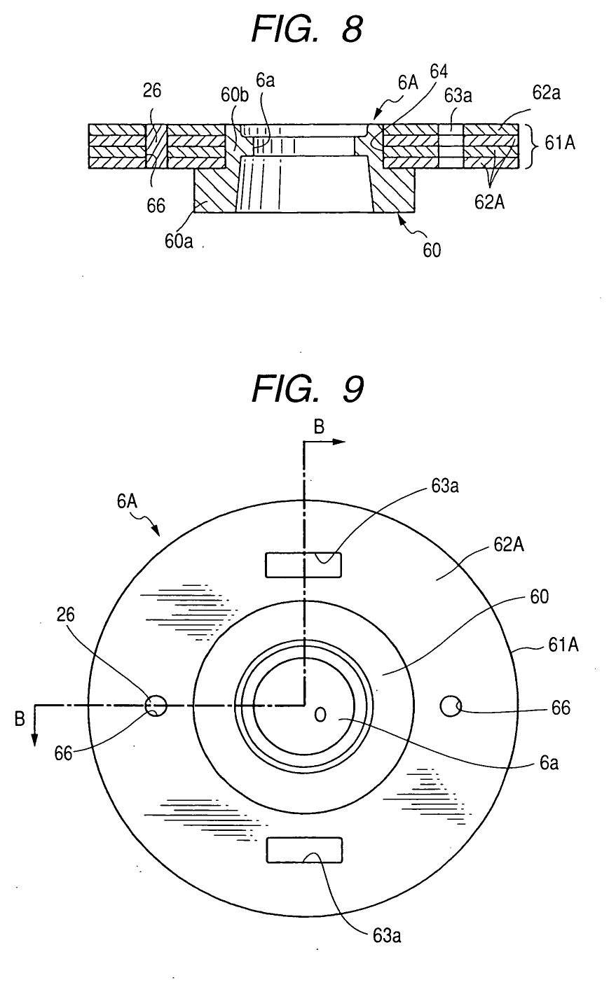

FIG. 8 is a cross sectional view of a stationary core 6A of a second embodiment according to the present invention, taken on line A-A of FIG. 9 passing across a center 0, which is a plan view showing the stationary core 6A.

With the second embodiment, the stationary core 6A includes the base section 60 and a disc section 61A that includes plural thin disc plates 62A secured to each other by means of positioning pins 26.

As shown in FIG. 9, the thin disc plate 62A is formed with two oblong through-bores 63a in first radially symmetric positions with respect to the center 0 and two small apertures 66 in second radially symmetric positions with respect to the center 0 and substantially perpendicular to an axis passing across centers of the oblong through-bores 63a.

Before assembling the disc section 61A onto the base portion 60, plural disc plates 62A are stacked and fixedly secured to each other under a condition where the plural disc plates 62A are positioned by means of positioning pins 26 fitted to the small apertures 66, respectively. In particular, in stacking the plural disc plates 62A, the small apertures 66 formed in the disc plates 62A are aligned in position along an axis of the disc section 61A, after which the positioning pins 26 are press fitted to the small apertures 66, respectively. This allows the plural disc plates 62A to be positioned such that the oblong through-bores 63a, formed in the plural disc plates 62A, respectively, communicate with each other in a stack direction (thickness direction).

The positioning pin 26 is designed to have a length substantially equal to a thickness of the disc section 61A composed of the stacked disc plates 62A. As shown in FIG. 8, under a condition wherein the positioning pins 26 are press fitted to the small apertures 66 of the stacked disc plates 62A, none of both ends of the positioning pins 26 protrudes from surfaces of the disc section 61A and both the positioning pins 26 remain in the same height as the thickness of the disc section 61A.

The disc section 61A, positioned with the positioning pins 26, is fixedly assembled to the base section 60 into one piece upon press fitting an outer periphery of the small diameter portion 60b of the base section 60 to an inner periphery of a round bore 64 of the disc section 61A.

With such a structure, no need arises for positioning the plural disc plates 62A one by one during assembly of the disc section 61A and the base section 60 like the stationary core 6 of the first embodiment, enabling a reduction in man-hour needed for assembly with the resultant increase in productivity.

Further, the disc section 61A has increased rigidities in fixing areas associated with the positioning pins 26. Accordingly, extracting the ground-side coil end 5c of the electromagnet coil 5 from the coil takeout opening 63a to allow the ground-side coil end 5c to extend to an area near one of the positioning pins 26, upon which the ground-side coil end 5c is jointed to a surface of the outermost disc plate 62A, enables a reduction in damage to a coil joint portion resulting from impact occurring when the plunger 8 is caused to strike the base section 60 of the stationary core 6. Thus, no need arises for working to be done to form a specifically contoured segment (such as, for instance, the press-out retaining lug 114 as shown in FIG. 12) on the disc plate 62a placed on the outermost layer of the disc section 61 for retaining the ground-side coil end 5c of the electromagnetic coil 5 on the outermost disc plate 62A (see FIG. 8). Therefore, the outermost disc plate 62A can be formed in the same structure as the other disc plates 62A, enabling a reduction in production cost.

In addition, none of the positioning pins 26 protrudes from the surfaces of the outermost layered disc plates 62A of the disc section 61A and the positioning pins 26 remain on the same height as the thickness of the disc section 61A. Thus, the positioning pins 26 provide no disturbances to work of welding or soldering the ground-side coil end 5c onto the surface of the disc plate 62A, providing improved workability with the resultant contribution to an increase in productivity.

### Third Embodiment

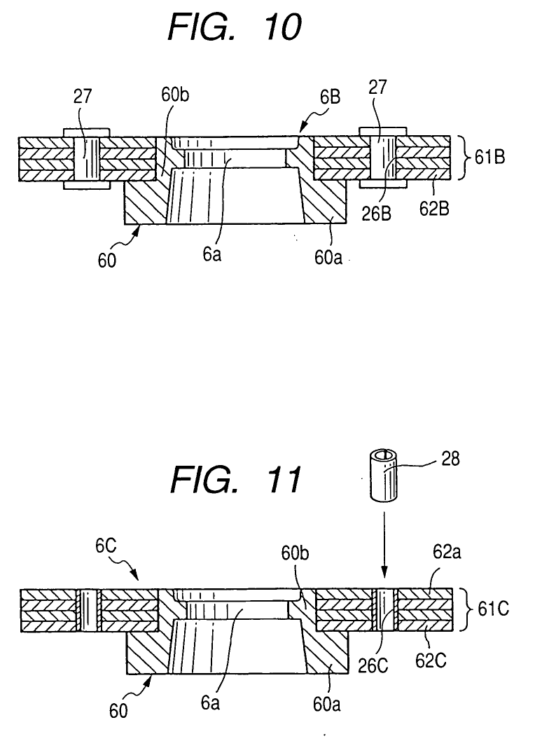

FIG. 10 is a cross sectional view of a stationary core 6B of a third embodiment according to the present invention.

With the third embodiment, the stationary core 6B comprises a base section 60 and a disc section 61B that includes plural disc plates 62B that are fixedly secured to each other by means of rivets 27 press fitted to small apertures 26B formed in the disc plates 62B. The use of the rivets 27 enable the plural disc plates 62B to be reliably fixed in a stacked direction (in a vertical direction).

### Fourth Embodiment

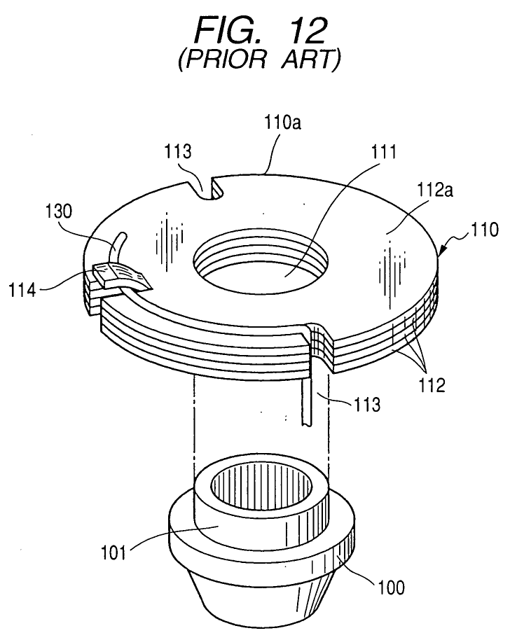

FIG. 11 is a cross sectional view of a stationary core 6C of a fourth embodiment according to the present invention.

With the fourth embodiment, the stationary core 6C comprises a base section 60 and a disc section 61C that includes plural disc plates 62C that are fixedly secured to each other by means of spring pins 28. press fitted to small apertures 26C formed in the disc plates 62C. The spring pins 28 are formed by rolling oblong metallic sheets into cylindrical shapes and inserted to small apertures 26C formed in the disc plates 62C upon which the spring pins 28 provides spring forces due to tendencies of expanding on inner peripheries of the small apertures 26C along circumferential directions thereof, thereby fixedly securing the stacked disc plates 62C with respect to each other.

With such a structure, like the second embodiment, none of the spring pins 28 protrudes from surfaces of the outermost disc plates 62C forming the disc section 61C, providing improved workability of welding or soldering the ground-side coil end 5c of the electromagnetic coil 5 to the surface of the disc plate 62C.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. An electromagnetic switch comprising:
an electromagnetic coil creating an electromagnet when energized;
a stationary core operative to be magnetized by the electromagnet created by the electromagnetic oil;
stationary electrical contacts fixedly disposed in a position away from the stationary core; and
a movable contact movable with a plunger attracted by the magnetized stationary core in a direction to close the stationary electrical contacts;
the stationary core including a base section and a disc section, assembled to the base section, which is disposed in an area on one side of the electromagnetic coil and has a coil takeout opening through which an end portion of the electromagnetic coil is extracted; and
the disc section including a plurality of stacked thin plates, formed in the same shapes, which have through-openings extending in a thickness direction of the disc section, respectively, and aligned to communicate with each other to form the coil takeout opening, and fixing means associated with the stacked thin plates to fixedly secure stacked thin plates with each other under a circumstance where the through-openings are aligned with each other with respect to a circumferential direction of the disc section.

2. The electromagnetic switch according to claim 1, wherein:
the end portion of the electromagnetic coil is extracted from the coil takeout opening of the disc section to one surface of the outermost layer of the stacked thin plates at a position remote from the electromagnetic coil and jointed to the one surface of the outermost layer of the stacked thin plates by one of welding and soldering; and
wherein the disc section has a fixing portion, through which the plurality of stacked thin plates are fixed by the fixing means, which has a height substantially equal to a thickness of the disc section.

3. The electromagnetic switch according to claim 2, wherein:
the end portion of the electromagnetic coil is jointed to the one surface of the outermost layer of the stacked thin plates by one of the welding and soldering at an area close proximity to the fixing portion.

4. The electromagnetic switch according to claim 1, wherein:
the stacked thin plates of the disc section are fixed to each other by caulking.

5. A method of manufacturing an electromagnetic switch, the method comprising the steps of:
preparing an electromagnetic coil creating an electromagnet when energized;
preparing a stationary core to be placed in a position adjacent to the electromagnetic coil;
fixedly mounting stationary electrical contacts in a position away from the stationary core; and
mounting a movable contact on a plunger operative to be attracted by the stationary core, when the electromagnetic coil is energized, to move in a direction to close the stationary electrical contacts;
the stationary core preparing step including the step of:
preparing a base section associated with the electromagnetic coil;
forming a plurality of thin plates having the same shapes and having through-openings, respectively;
stacking the plurality of thin plates in a way to allow the through-openings to be aligned with each other with respect to a circumferential direction;
caulking the stacked thin plates at a caulked portion in a lump to prepare a disc section;
assembling the disc section and the base section into the stationary core; and
extracting an end portion of the electromagnetic coil through the takeout opening.

6. The method of manufacturing the electromagnetic switch according to claim 5, wherein:
the step of forming a plurality of thin plates includes the steps of:
forming the thin plates by punching; and
forming the caulked portion, to be caulked, by press forming.

7. A method of manufacturing an electromagnetic switch, the method comprising the steps of:
preparing an electromagnetic coil creating an electromagnet when energized;
preparing a stationary core to be placed in a position adjacent to the electromagnetic coil;
fixedly mounting stationary electrical contacts in a position away from the stationary core; and
mounting a movable contact on a plunger operative to be attracted by the stationary core, when the electromagnetic coil is energized, to move in a direction to close the stationary electrical contacts;
the stationary core preparing step including the step of:
preparing a base section associated with the electromagnetic coil;
forming a plurality of thin plates having the same shapes and having through-openings, respectively;
stacking the plurality of thin plates in a way to allow the through-openings to be aligned with each other with respect to a circumferential direction;
caulking the stacked thin plates at a caulked portion one by one in a sequence to prepare a disc section;
assembling the disc section and the base section into the stationary core; and
extracting an end portion of the electromagnetic coil through the takeout opening.

8. The method of manufacturing the electromagnetic switch according to claim 7, wherein:
the step of forming a plurality of thin plates includes the steps of:
forming the thin plates by punching; and
forming the caulked portion, to be caulked, by press forming.

9. An electromagnetic switch comprising:
an electromagnetic coil creating an electromagnet when energized;
a plunger movably disposed in the electromagnetic coil and having a shaft axially extending from one end of the plunger;
a stationary core associated the electromagnetic coil and operative to be magnetized by the electromagnet created by the electromagnetic oil;
stationary electrical contacts disposed in positions away from the stationary core; and
a movable contact, carried on one end of the shaft, which is normally urged in a position to open the electrical contacts and movable in a direction to close the stationary electrical contacts when the stationary core is magnetized by the electromagnetic coil;
the stationary core including a base section, and a disc section, assembled to the base section, which is disposed in an area on one side of the electromagnetic coil and has a coil takeout opening through which an end portion of the electromagnetic coil is extracted; and
the disc section including a plurality of stacked thin plates, formed in the same shapes, which have through-openings extending in a thickness direction of the disc section, respectively, and aligned to communicate with each other to form the coil takeout opening.

10. The electromagnetic switch according to claim 9, wherein:
the stacked thin plates are fixedly secured to each other by caulking under a circumstance where the through-openings are aligned with each other with respect to a circumferential direction of the disc section in communication with each other.

11. The electromagnetic switch according to claim 9, wherein:
the stacked thin plates are fixedly secured to each other by a positioning pin press fitted to the stacked thin plates under a circumstance where the through-openings are aligned with each other with respect to a circumferential direction of the disc section in communication with each other.

12. The electromagnetic switch according to claim 9, wherein:
the stacked thin plates are fixedly secured to each other by a rivet inserted to the stacked thin plates under a circumstance where the through-openings are aligned with each other with respect to a circumferential direction of the disc section in communication with each other.

13. The electromagnetic switch according to claim 9, wherein:
the stacked thin plates are fixedly secured to each other by a spring pin inserted to the stacked thin plates under a circumstance where the through-openings are aligned with each other with respect to a circumferential direction of the disc section in communication with each other.

14. The electromagnetic switch according to claim 9, wherein:
the end portion of the electromagnetic coil is extracted from the coil takeout opening of the disc section to one surface of the outermost layer of the stacked thin plates at a position remote from the electromagnetic coil and jointed to the one surface of the outermost layer of the stacked thin plates by one of welding and soldering; and
wherein the disc section has a fixing portion, through which the plurality of stacked thin plates are fixed by the fixing means, which has a height substantially equal to a thickness of the disc section.

15. The electromagnetic switch according to claim 14, wherein:
the end portion of the electromagnetic coil is jointed to the one surface of the outermost layer of the stacked thin plates by one of welding and soldering at an area close proximity to the fixing portion.
